(19) United States
(12) Patent Application Publication
(10) Pub. No.: US 2012/0216742 A1
(43) Pub. Date: Aug. 30, 2012

(54) Timing Whistle

(76) Inventors: Stephen Lee Walker, Chippewa Lake, MI (US); Pauline Walker-Henry, Chippewa Lake, MI (US); Pamela P. Gillespie, Grant, MI (US); Kimberly Doane, Grant, MI (US)

(21) Appl. No.: 13/036,072

(22) Filed: Feb. 28, 2011

(51) Int. Cl. G01D 11/00

(52) U.S. Cl. 116/200

(57) ABSTRACT

A timing whistle for setting the timing of an internal combustion engine comprising: a threaded tip, where the tip provides a means for coupling the whistle into a spark plug port; a means to rotate and secure the whistle into the spark plug port; a body portion, where said body portion extends from the means to rotate and secure; and an opening along the body portion, where said opening provides a means for the emission of a whistling sound indicating optimum timing of the engine. In one particular embodiment, the means to rotate includes a bolt type assembly and the body portion includes a pipe and a cap attached to the bolt assembly.

### BACKGROUND OF THE INVENTION

1. Field of Invention

The present invention relates to a device to assist in setting the timing of an internal combustion engine.

2. Description of Related Art

Ignition timing is an essential aspect related to the function of an internal combustion engine. The setting of the ignition timing occurs in the combustion chamber based upon the piston position and crankshaft angler velocity. The setting of the correct ignition timing is crucial to the performance of an engine and consequently affects the engine longevity, fuel economy and power. Many modern engines use an electronic or computerized engine control unit to control the timing throughout the engine's RPM range. Older engines use a mechanical spark distributor that relies on the inertia and manual manifold vacuum in order to set the ignition timing. It may be necessary for an individual to adjust the timing on an engine due to changes in the engine such as upgrades or modifications of the initial designs.

Older engines that utilize distributors to control the firing of spark plugs consequently must correctly set the ignition timing in order to have an effective and efficient operating engine. Various mechanical gages have been developed in order to provide a means to set the ignition timing and to ensure the ignition takes place when the engine hits top dead center during the compression stroke. U.S. Pat. No. 2,579,710 discloses an audible piston indicator where the indicator includes a reducer type coupling or adapter and axially carried by the coupling, a vibratory pressure responsive reed and a reed holder carrying the reed and removably mounted in the cylinder.

U.S. Pat. No. 2,511,392 discloses a piston-actuated rod that may be inserted through the spark plug socket and aperture of any cylinder in a conventional internal combustion engine. The device of the '392 patent provides a light or audible signal when the piston reaches the top dead center position and therefore provides an indication of ignition timing.

U.S. Pat. No. 6,050,135 discloses yet another device that is utilized to accurately set the timing position that forms a seal at the spark plug port and creates a pressure vessel inside the combustion chamber so that as the pressure in the chamber increases, the device is dislodged and expelled with the audible sound similar to a champagne cork. Further development of a unique and yet simple effective device to determine top dead center and effectively set the ignition timing of an internal combustion engine is therefore readily needed.

### SUMMARY OF THE INVENTION

The present invention relates to a timing whistle for setting the timing of an internal combustion engine comprising: a threaded tip, where the tip provides a means for coupling the whistle into a spark plug port; a means to rotate and secure the whistle into the spark plug port; a body portion, where said body portion extends from the means to rotate and secure; and an opening along the body portion, where said opening provides a means for the emission of a whistling sound indicating optimum timing of the engine. In one particular embodiment, the means to rotate includes a bolt type assembly and the body portion includes a pipe and a cap attached to the bolt assembly.

### BRIEF DESCRIPTION OF DRAWINGS

FIG. 1 depicts a timing whistle according to the present invention.

### DETAILED DESCRIPTION

The present invention relates to a timing whistle that is utilized to assist in setting the timing associated with an internal combustion engine. The timing whistle according to the present invention is utilized to screw into the No. 1 cylinder and provide an audible sound indicating that the engine had been set at a proper timing position. The timing whistle according to present invention provides an easy to use and readily accessible device to set the timing associated with an engine.

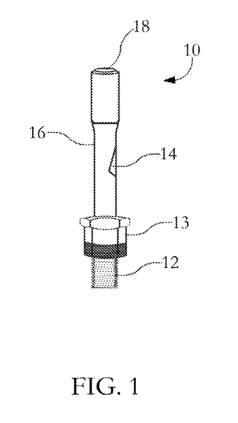

A timing whistle 10 as depicted in FIG. 1 may be utilized for setting ignition timing. The timing whistle 10 includes a threaded tip 12 that is used to insert the whistle 10 into the No. 1 cylinder of an internal combustion engine. The threaded tip 12 is similar to the tip of a spark plug and therefore seals off the cylinder in order to provide an accurate measurement of pressure within the cylinder. Above the threaded tip 12 is a bolt type assembly 13 that provides a means for the attachment of proper tooling to rotate and secure the timing whistle 10 into place. The body of the timing whistle 10 includes a pipe 16 and a cap 18 attached to the bolt 13. Along the pipe 16 is an opening 14 that provides a means for the emission of a whistling sound when setting the timing on the engine.

The timing whistle 10 provides the determination of top dead center while an individual is attempting to set the timing of the engine. Once the threaded tip 12 is inserted into the No. 1 cylinder and seals off the ignition plug port of the cylinder, an individual may begin to turn the engine until the audible whistle may be heard through the opening 14. Once the audible whistle sounds, the individual knows that the piston has reached an optimum setting and therefore the timing can be set based upon this audible sound. The opening 14 is configured at a predetermined size that coincides with the pressure within the cylinder. As the engine is turned and the piston reaches top dead center, the pressure within the cylinder therefore increases to the point where the audible whistle sounds through the opening 14.

The present invention may be manufactured by using a modified spark plug where the ceramic body and tip are removed and replaced with the pipe 16. After the removable of the ceramic tip or insulator, the insertion of the pipe over the metal case creates the timing whistle 10 as contemplated by the present invention. Use of the timing whistle in accordance with the present invention ensures that the engine timing is properly set and provides a means for optimizing engine performance. The timing whistle according to present invention is also cost-effective, easy to use and provides a mechanic with a convenient tool to utilize when setting the timing of an internal combustion engine. The instant invention has been shown and described in what it considers to be the most practical and preferred embodiments. It is recognized, however, that departures may be made there from within the scope of the invention and that obvious modifications will occur to a person skilled in the art.

What is claimed is:

1. A timing whistle for setting the timing of an internal combustion engine comprising:
a. a threaded tip, where the tip provides a means for coupling the whistle into a spark plug port;’
b. a means to rotate and secure the whistle into the spark plug port;
c. a body portion, where said body portion extends from the means to rotate and secure; and
d. an opening along the body portion, where said opening provides a means for the emission of a whistling sound indicating optimum timing of the engine.

2. The timing whistle according to claim 1, wherein the means to rotate includes a bolt type assembly.

3. The timing whistle according to claim 2, where the body portion includes a pipe and a cap attached to the bolt assembly.

4. The timing whistle according to claim 1, where the opening in configured at a predetermined size that coincides the pressure within the cylinder.

5. The timing whistle according to claim 1, where the whistle is manufactured by using a modified spark plug.
